(19) United States
(12) Patent Application Publication
(10) Pub. No.: US 2025/0148758 A1
(43) Pub. Date: May 8, 2025

(54) JOINT ASSET AND DEFECT DETECTION MACHINE LEARNING MODEL

(71) Applicant: X Development LLC, Mountain View, CA (US)

(72) Inventors: Xin-Jing Wang, Mountain View, CA (US); Anthony Ha, Milpitas, CA (US)

(21) Appl. No.: 18/935,234

(22) Filed: Nov. 1, 2024

Related U.S. Application Data
(60) Provisional application No. 63/596,355, filed on Nov. 6, 2023.

(51) Int. Cl. G06V 10/764; G06T 11/00; G06V 10/26; G06V 10/77; G06V 10/82; G06V 20/10; G06V 20/70

(52) U.S. Cl. CPC G06V 10/764; G06T 11/00; G06V 10/273; G06V 10/7715; G06V 10/82; G06V 20/176; G06V 20/70; G06T 2210/12

(57) ABSTRACT

This disclosure describes a system, method, and computer storage medium for joint asset and defect detection. The approach includes receiving input data including an input image of a utility asset, the input image including one or more objects. Deep neural networks are configured to generate embeddings for classification labels of the one or more objects, each embedding corresponding to a classification label and including a mapping between the classification label and a subset of feature vectors. Defect classifiers are configured to determine a likelihood of an object from the one or more objects in the input image containing a type of defect. Each defect classifier is trained to determine a type of defect based on the embeddings for the one or more classification labels. The approach includes generating an output image that includes bounding boxes for the objects and an annotation corresponding a respective object from the objects.

### CROSS REFERENCE TO RELATED APPLICATIONS

This application is a non-provisional of and claims priority to U.S. Provisional Patent Application No. 63/596,355, filed on Nov. 6, 2023, the entire contents of which are hereby incorporated by reference.

### BACKGROUND

This disclosure generally relates to images of utility assets, including images capturing defects of utility assets.

Utility assets (e.g., transformers, network protectors, cables, utility poles, power stations, and substations) develop defects while distributing and transmitting power for an electrical grid. Different types of utility assets perform complex functions to provide power from the electrical grid to loads at voltage and current levels suitable for residential, industrial, and commercial applications. Some types of utility assets experience different types of defects (e.g., corrosion, wear and tear, environmental factors, and other types of physical damage), with varying impact to the performance and life cycle of the utility asset.

There is a growing interest in leveraging the images of different types of utility assets and defects captured to identify both defect and asset type of the utility asset to take preventative action to prevent operational failure of the utility asset.

### SUMMARY

This specification describes techniques that involve a system, and operations for an asset-defect detection for identifying utility asset type and defect status (including defect classes) from input images of utility assets to generate annotated output images. The disclosed technology relates to a joint model for asset-defect detection that can be configured to predict types of utility assets and their corresponding defective status or type from images. The joint model is configured to perform long-tail object detection on utility asset types and defects, as the defects for different types of utility assets can demonstrate a long-tail distribution. The joint model is trained to jointly classify asset type and defect status of utility assets by using feature data from asset classifications to determine the defect status. In contrast to separately training two models to perform asset classification and defect detection separately, the joint model leverages the long-tailed nature of training examples and data.

Images of a particular type of utility asset can be captured during the lifecycle of the utility asset, e.g., by utility workers during inspections, maintenance, and other types of work performed on the utility asset. Images of utility assets can also be captured by cameras mounted vehicles, e.g., automotive vehicles, unmanned aerial vehicles. Some types of utility asset defects occur at a much higher frequency than others, e.g., a long tail distribution of defect, type of utility asset, or some combination thereof. The joint model is trained to jointly classify asset type and defect status of utility assets by using feature data from asset classifications to determine the defect status. In contrast to separately training two models to perform asset classification and defect detection separately, the joint model leverages the long-tailed nature of training examples and data.

The joint model allows for re-use of training examples because it can be trained to classify assets and differentiate non-defect and defect statuses for an asset, thereby providing an improvement in asset and defect classification that leverages the long-tailed nature of training examples for defect statuses and classes of different asset types. The joint model utilizing asset classifications can be dependent on defect status because defects and non-defect assets are two statuses of the same detected object, e.g., the utility asset for the asset type. The training process for the joint model is a two stage approach. The first stage of the joint model is an asset detection model that is trained without differentiating assets and defects, that leverages all available data because non-defective and defective (being two statuses of the same object) can share visual signals and feature data. The second stage includes fine-tuning the joint model to differentiate non-defect assets and defects by generalizing detection to handle different statuses of the same classes by efficient grouping of the classes without mixing defect status.

For example, groupings of training examples can be generated without mixing the defective and non-defective version of the same asset in the same groupings. This adjustment can be supported because defect training examples are generally long-tail classes, e.g., having a long-tail distribution, as described in reference to FIG. 2B below. The joint model provides an ensemble of binary classifiers to perform defect detection from outputs of the first stage to detect non-defective and defective assets. In this way, an aggregated softmax activation function (e.g., rather than a group softmax) can be applied to an ensemble approach for asset and defect detection. An aggregated softmax can reduce the number of classes by aggregating classes into larger groups, thereby reducing computational complexity, memory consumption, and power consumption by computing systems and devices for asset and defect detection of utility assets in the electric grid.

Particular implementations of the subject matter described in this specification can be implemented to realize one or more of the following technical advantages. As described in this specification, utility assets can include a wide variety of defects that are difficult to detect. In some cases, there are few examples of particular types, instances, or some combination thereof, of utility asset defects that are captured and stored in image databases. The asset-defect detection system includes a joint asset and defect detection model, also referred to as a “joint model” that provides a tailored approach detecting and identifying asset defects represented by an input set of images, to generate object annotations in an output set of images.

Some approaches for modeling the electric grid classify assets and defects separately, e.g., no mixing of asset and defect features, which can overlap for some types of asset and defect statuses of utility assets. The joint model is trained and fine-tuned for detecting and classifying utility assets, particularly with training examples that have a long-tail distribution. For example, some types of utility assets are long-tailed in that some defects are relatively uncommon and difficult to train for, e.g., compared to training examples with large class sizes. The feature data from asset features can improve classification of asset status, but can also improve detection of defect status, e.g., in addition to defect feature data. Some defects are shared across different types of assets, e.g., corrosion can only occur for certain types of assets, and the joint model leverages features learned from defect status across different types of utility assets to predict both asset type and defect status of a utility asset in images.

The techniques disclosed in this specification include tailoring the joint model for asset and defect detection, thereby providing a joint model that enables an ensemble of binary classifiers to predict defect status from classified assets identified in an image. The feature data related to asset type and defect status is used for training and inference tasks for the joint model, e.g., asset classification and defect status detection. The joint model provides improved classification accuracy of utility assets, which can help identify and prioritize types of utility assets for rehabilitation, repair, replacement, etc. For example, the disclosed technology employs techniques of bucketizing different classes of objects (e.g., groupings) based on number of examples, such as keeping buckets for defective version and non-defective versions of the same bucket separate from each other. This is feasible because the defective assets have few training examples and will inherently be in a different bucket than the non-defective version. Each bucket includes an “others” class representing sampled images from classes of other buckets. Furthermore, each object class can be detected by the first stage deep neural network and the deep neural network can sample an embedding representing an opposite class (same asset, but different defect status) for that class. As an example, the embedding for a non-defective utility pole can be processed by an object classifier trained to classify a type of defect, in which the object classifier samples training data from defective utility poles. Each class of object can be individually classified to identify their respective status, e.g., defective, or non-defective. In this way, the joint model is configured to classify both the object type and defect status of utility assets in an image, e.g., with a bounding box and an annotation indicating object class, defect status, and a likelihood of the detected object having the object class and defect status.

The joint model also enables digitization of grid assets from images of utility assets to build a simulation, model, and/or digital mapping of utility assets. The digitization of the electric grid can improve grid planning and operations. The annotated output images generated by the joint model can provide improvements in electric grid operation and planning by providing predictions of utility asset type and defect status without the need for invasive electrical testing and dispatching utility crews. The annotated output images can also be combined with electrical grid data to create an improved digital map, e.g., leveraging image features and electric grid asset data to improve electric grid model capabilities.

These and other implementations can each optionally include one or more of the following features.

In an aspect, a method for joint asset and defect detection includes receiving input data including an input image of a utility asset, the input image including one or more objects. The method includes generating, by one or more deep neural networks, embeddings for one or more classification labels of the one or more objects in the input images, each embedding corresponding to a classification label and including a mapping between the classification label and a subset of feature vectors. The method includes determining, by a plurality of defect classifiers, a likelihood of an object from the one or more objects in the input image containing a type of defect. Each defect classifier from the plurality of defect classifiers is trained to determine a type of defect based on the embeddings for the one or more classification labels. The method includes generating an output image including the plurality of bounding boxes for the one or more objects in the input image, and an annotation corresponding a respective object from the one or more objects in the input image.

In some implementations, the method includes generating, by one or more deep neural networks, the plurality of bounding boxes for the one or more objects in the input image. Each bounding box in the plurality of bounding boxes corresponds to an object from the one or more objects in the input image for the utility asset.

In some implementations, the method includes generating, by one or more deep neural networks, asset label data for the one or more objects in the input image. The asset label data includes the one or more classification labels corresponding to the one or more objects in the input image, each classification label representing a type of utility asset.

In some implementations, the method includes generating, by one or more deep neural networks, asset feature data for one or more objects in the input image. The asset feature data includes a plurality of feature vectors, the feature vectors representing features of the one or more objects in the input image. The subset of feature vectors includes at least one of the plurality of feature vectors.

In some implementations, the method includes generating, by one or more images and a machine learning model configured to jointly perform asset and defect detection, a model of an electric grid.

In some implementations, the corresponding bounding box for an object indicates a position of the respective object in the output image.

In some implementations, the annotation includes a classification label and a likelihood associated with the classification label, the classification label indicating an asset type and defect status for the respective object, and the likelihood associated with the classification label represents a probability of the respective object in the input image matching the asset type and the defect status.

In an aspect, a method for training a joint asset and defect detection model includes obtaining a plurality of training examples. Each training example in the plurality of training examples includes (i) feature data from an image of a utility asset, (ii) an annotation, and (iii) classifier weightings corresponding to the annotation for the utility asset in the image. The annotation can include a label indicating a defect status of (i) defective, or (ii) non-defective. The method includes generating a plurality of groupings for the plurality of training examples. The plurality of training examples can be divided among the plurality of groupings based on a count of unique training examples among the plurality of training examples, each grouping including training examples that share a count within a threshold value. The method includes applying, to each grouping in the plurality of groupings, an activation function to the classifier weightings corresponding to the annotation for the training examples of the grouping. The method includes generating, for each grouping in the plurality of groupings, a first additional class representing a subset of training examples that are not included in the grouping. The method includes generating a first additional grouping. The first additional grouping can be an empty grouping. The method includes sampling, for each grouping in the plurality of groupings, the feature data for training examples in the same grouping. The sampled feature data is configured to be stored in the first additional class of the grouping. The method includes generating, by a plurality of defect classifiers and based on the sampled feature data from the first additional classes of the plurality of groupings, a predicted annotation. The method includes updating one or more weights of at least one defect classifier in the plurality of defect classifiers based on a comparison of the predicted annotation and the annotation for a training example.

In some implementations, the annotation indicates a type and defect status of the utility asset in the image and the predicted annotation indicates a predicted type and a predicted defect status of the utility asset in the image.

In some implementations, the method includes up-sampling, for each grouping in the plurality of groupings, a subset of training examples, each training example in the subset including a defect status with a label of defective. Up-sampling the grouping can include sampling corresponding feature data of the subset of training examples at least one additional time when training the plurality of defect classifiers.

In some implementations, the method includes normalizing, for each grouping in the plurality of groupings, the classifier weightings for training examples with a number of counts exceeding a threshold value in the grouping.

In some implementations, the utility asset is at least one of (i) a utility pole, (ii) a transformer, (iii) one or more wires, or (iv) other types of electrical grid distribution equipment.

In some implementations, the plurality of defect classifiers are configured to determine, based on embeddings generated for one or more classification labels of one or more objects, an updated bounding box for an output image. The updated bounding box can have a higher likelihood of identifying an object in an input image than the respective bounding box for the object from the plurality of bounding boxes.

In some implementations, generating the predicted annotation for one or more objects in an input image includes providing a training example to a model configured to perform asset-defect detection. The training example can include (i) a classification label for a respective object of the one or more objects indicating a type of utility asset and (ii) an annotation for the respective object of the one or more objects indicating a defect status of the utility asset.

In an aspect, a system for joint asset and defect detection one or more computers and one or more storage devices storing instructions that are operable, when executed by the one or more computers, to cause the one or more computers to perform operations. The operations include receiving input data including an input image of a utility asset, the input image including one or more objects. The operations include generating, by one or more deep neural networks, embeddings for one or more classification labels of the one or more objects in the input images, each embedding corresponding to a classification label and including a mapping between the classification label and a subset of feature vectors. The operations include determining, by a plurality of defect classifiers, a likelihood of an object from the one or more objects in the input image containing a type of defect. Each defect classifier from the plurality of defect classifiers can be trained to determine a type of defect based on the embeddings for the one or more classification labels. The operations include generating an output image including the plurality of bounding boxes for the one or more objects in the input image, and an annotation corresponding a respective object from the one or more objects in the input image.

In some implementations, the operations include obtaining a plurality of training examples. Each training example in the plurality of training examples can include (i) feature data from an image of a utility asset, (ii) an annotation, and (iii) classifier weightings corresponding to the annotation for the utility asset in the image. The annotation can include a label indicating a defect status of (i) defective, or (ii) non-defective. The operations include generating a plurality of groupings for the plurality of training examples. The plurality of training examples can be divided among the plurality of groupings based on a count of unique training examples among the plurality of training examples, each grouping including training examples that share a count within a threshold value. The operations include applying, to each grouping in the plurality of groupings, an activation function to the classifier weightings corresponding to the annotation for the training examples of the grouping. The operations include generating, for each grouping in the plurality of groupings, a first additional class representing a subset of training examples that are not included in the grouping. The operations include generating a first additional grouping. The first additional grouping can be an empty grouping. The operations include sampling, for each grouping in the plurality of groupings, the feature data for training examples in the same grouping. The sampled feature data can be configured to be stored in the first additional class of the grouping. The operations include generating, by a plurality of defect classifiers and based on the sampled feature data from the first additional classes of the plurality of groupings, a predicted annotation. The operations include updating one or more weights of at least one defect classifier in the plurality of defect classifiers based on a comparison of the predicted annotation and the annotation for a training example.

In some implementations, the operations include generating, by one or more deep neural networks, the plurality of bounding boxes for the one or more objects in the input image. Each bounding box in the plurality of bounding boxes can correspond to an object from the one or more objects in the input image for the utility asset.

In some implementations, the operations include generating, by one or more deep neural networks, asset label data for the one or more objects in the input image. The asset label data can include the one or more classification labels corresponding to the one or more objects in the input image, each classification label representing a type of utility asset.

In some implementations, the operations include generating, by one or more deep neural networks, asset feature data for one or more objects in the input image, the asset feature data can include a plurality of feature vectors, the feature vectors representing features of the one or more objects in the input image, and the subset of feature vectors can include at least one of the plurality of feature vectors.

In some implementations, the annotation includes a classification label and a likelihood associated with the classification label, the classification label indicating an asset type and defect status for the respective object, and the likelihood associated with the classification label represents a probability of the respective object in the input image matching the asset type and the defect status.

In an aspect, a computer storage medium encoded with instructions that are operable, when executed by data processing apparatus, to cause the data processing apparatus to perform the operations. The operations include receiving input data that includes an input image of a utility asset, the input image including one or more objects. The operations include generating, by one or more deep neural networks, embeddings for one or more classification labels of the one or more objects in the input images. Each embedding corresponds to a classification label and includes a mapping between the classification label and a subset of feature vectors. The operations include determining, by a plurality of defect classifiers, a likelihood of an object from the one or more objects in the input image containing a type of defect. Each defect classifier from the plurality of defect classifiers is trained to determine a type of defect based on the embeddings for the one or more classification labels. The operations include generating an output image including the plurality of bounding boxes for the one or more objects in the input image, and an annotation corresponding a respective object from the one or more objects in the input image.

In some implementations, the operations include obtaining a plurality of training examples, each training example in the plurality of training examples including (i) feature data from an image of a utility asset, (ii) an annotation, and (iii) classifier weightings corresponding to the annotation for the utility asset in the image. The annotation can include a label indicating a defect status of (i) defective, or (ii) non-defective. The operations can include generating a plurality of groupings for the plurality of training examples. The plurality of training examples can be divided among the plurality of groupings based on a count of unique training examples among the plurality of training examples, each grouping including training examples that share a count within a threshold value. The operations can include applying, to each grouping in the plurality of groupings, an activation function to the classifier weightings corresponding to the annotation for the training examples of the grouping. The operations can include generating, for each grouping in the plurality of groupings, a first additional class representing a subset of training examples that are not included in the grouping. The operations can include generating a first additional grouping. The first additional grouping can be an empty grouping. The operations can include sampling, for each grouping in the plurality of groupings, the feature data for training examples in the same grouping. The sampled feature data can be configured to be stored in the first additional class of the grouping. The operations can include generating, by a plurality of defect classifiers and based on the sampled feature data from the first additional classes of the plurality of groupings, a predicted annotation. The operations can include updating one or more weights of at least one defect classifier in the plurality of defect classifiers based on a comparison of the predicted annotation and the annotation for a training example.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram of an example joint asset-defect detection system detecting asset type and defect class from input images and providing annotated output images.

FIG. 1B is a diagram of example stages and substages for training the joint asset-defect detection system of FIG. 1A.

FIG. 1C is a diagram of another example for training the joint asset-defect detection system of FIG. 1A.

FIG. 2A is an example table depicting counts of utility asset and defect labels.

FIG. 2B is an example histogram depicting a long-tail distribution of the counts in FIG. 2A.

FIG. 3 is an example of annotated output images generated by a joint asset-defect detection system.

FIG. 4A is a flowchart illustrating an example process performed by a joint asset-defect detection system.

FIG. 4B is a flowchart illustrating an example training process performed by a joint asset-defect detection system.

FIG. 5 is a schematic diagram of a computer system.

### DETAILED DESCRIPTION

In general, the disclosure relates to a method, system, and non-transitory, computer-readable medium for performing joint asset and defect detection of utility assets from images. Image databases can include numerous (e.g., millions) of images of utility assets, such as utility poles/posts, transformers, network protectors, switches, cables, wires, and other types of electrical equipment. Although image databases include images that capture various types of defects of electrical equipment, the large volume of images can be difficult to parse for a particular type of defect, e.g., to provide all images capturing utility assets with the particular type of defect. Therefore, it is difficult to determine patterns or insights of types of defects from image data to improve electric grid operation, e.g., prioritizing the replacement or refurbishment of the utility asset.

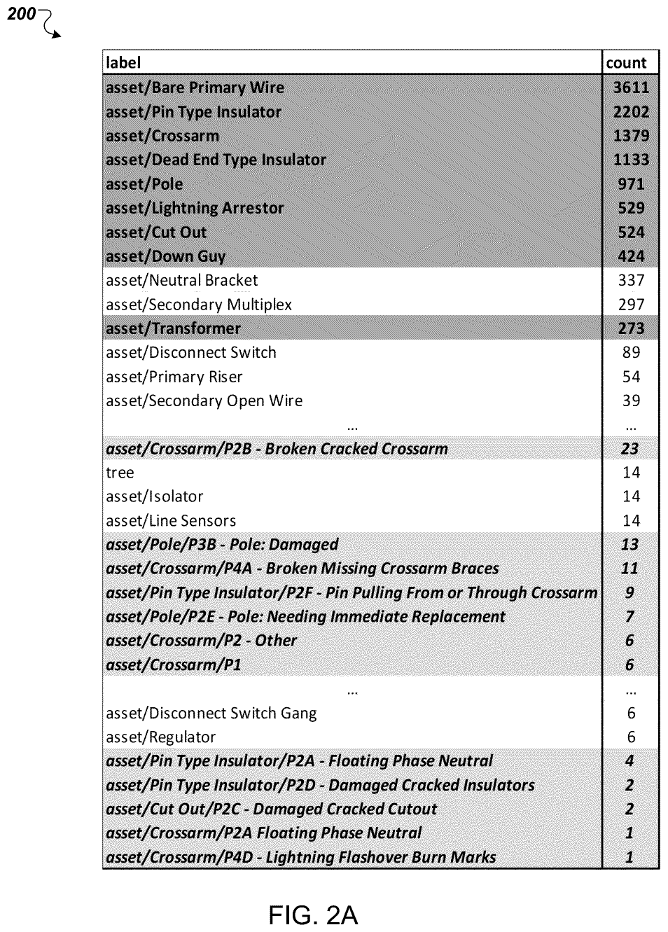

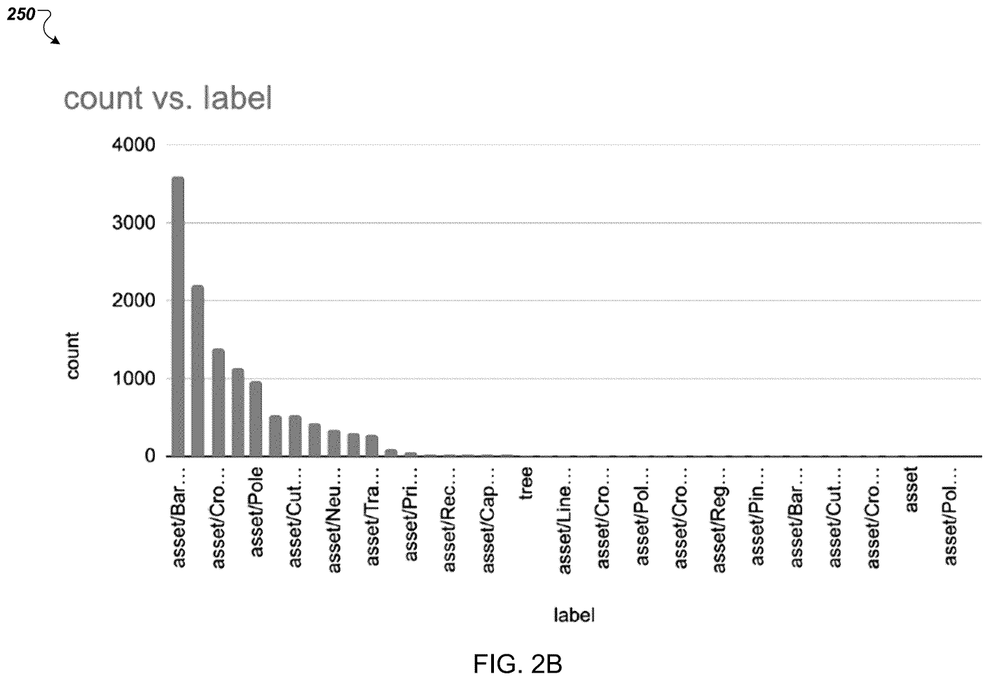

Some approaches for modeling the electric grid include determining which type of utility assets are in the electric grid, i.e., the assets that are functioning in the grid. There are some difficulties for utility companies, operators, and analysts to identify locations of which types of assets are deployed in the field, the locations of the utility assets, and the defect status of the utility asset. In some cases, utility crews are dispatched to manually examine utility assets, which can include difficult to reach locations, e.g., utility poles, long wires across large amounts of land. These approaches can also include tailoring an object detection model to predict utility assets and defects. However, these approaches do not account for different population sizes across different asset types, e.g., unbalanced data. Unbalanced training data can include some assets that are head classes while other assets and defects are long-tail classes, as described in referenced to FIGS. 2A and 2B below.

The application of computer vision and artificial intelligence techniques disclosed by this specification provide improvements in asset and defect detection. The joint asset and defect detection model (also referred to as “a joint model”) can be configured to generate a reconstruction of a physical grid by utilizing images collected from cameras. In some cases, images are captured by vehicles, e.g., cars, planes, and drones to collect images of the grid. The joint model can be configured to transform annotations of images of utility assets into asset and defect markers on a digital map, e.g., translating the physical grid into a digital map that can be configured for grid planning and simulation.

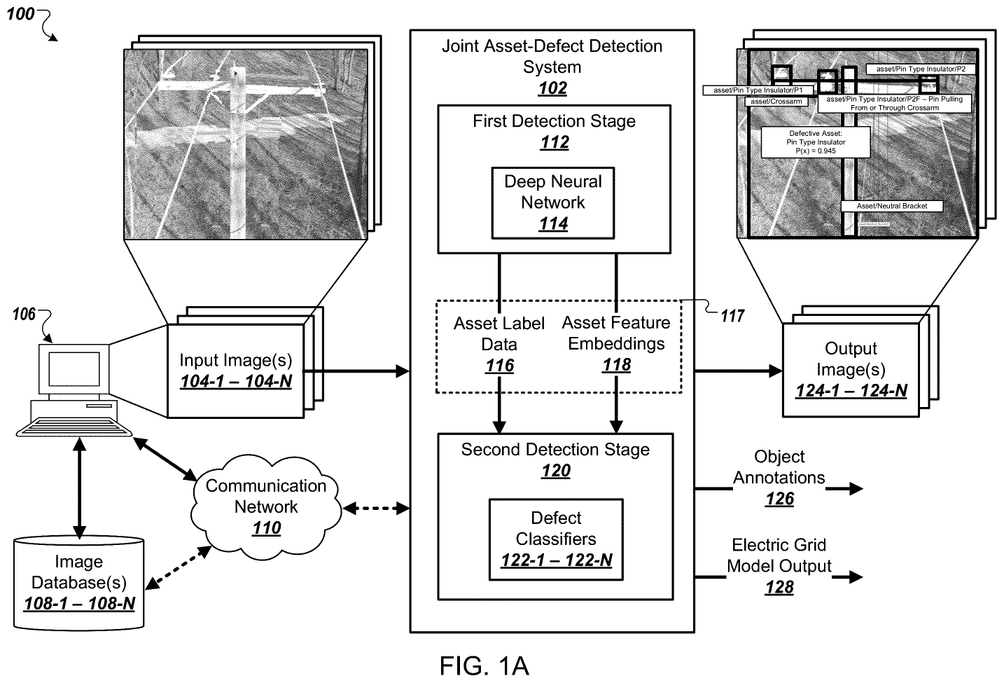

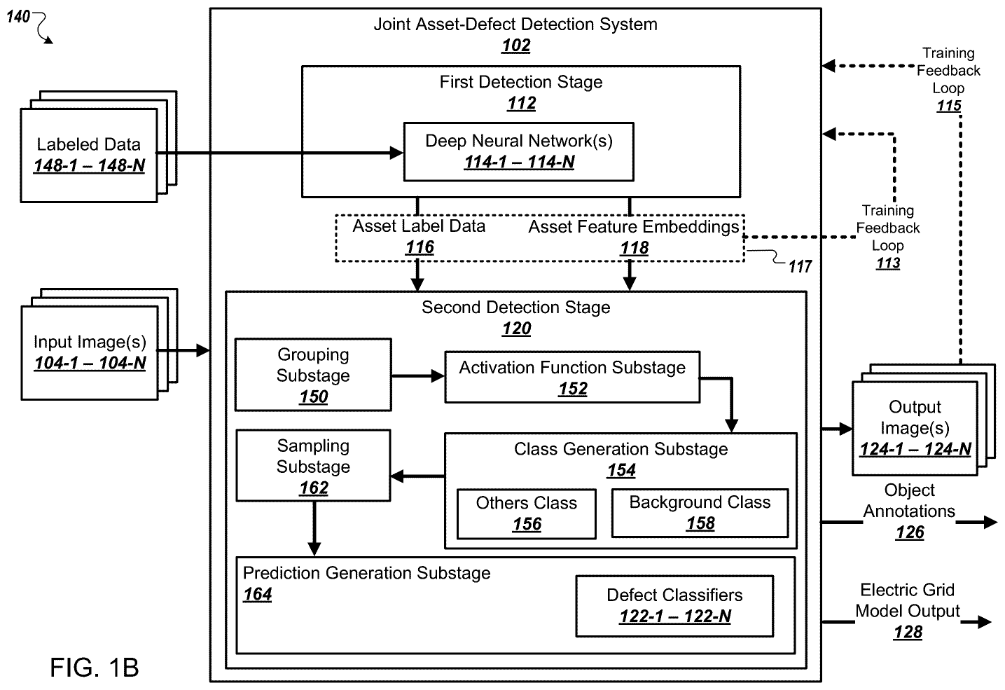

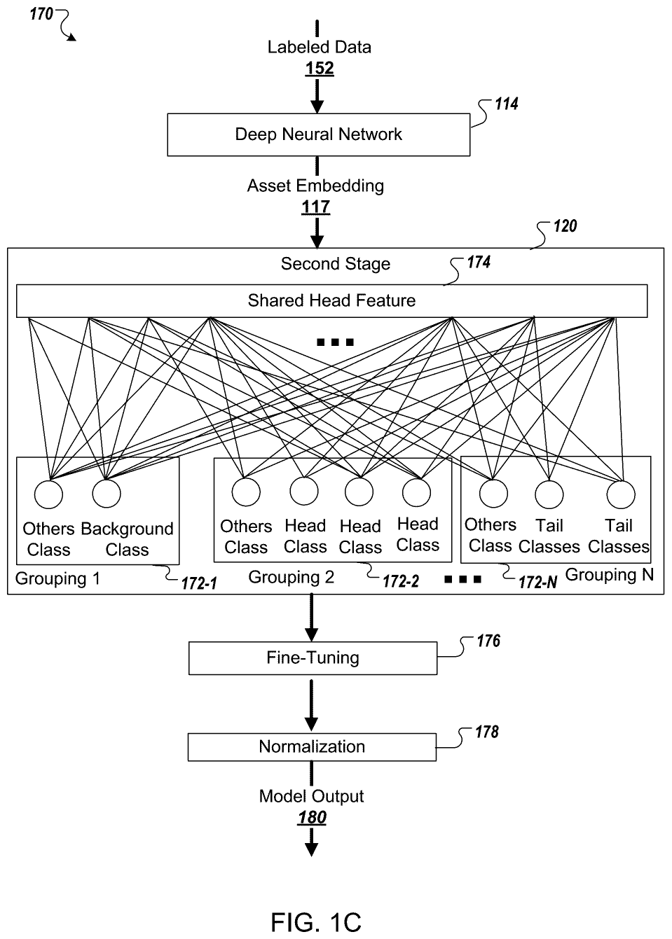

FIG. 1A is a diagram of an example joint asset-defect detection system 102 detecting asset type and defect class from input images and providing annotated output images. An environment 100 depicted in FIG. 1A shows input images 104-1 through 104-N (collectively “input images 104”) as an input of the joint asset-defect detection system 102 (also referred to as “asset-defect detection system 102” or “system 102”) and output images 124-1 through 124-N (collectively “output images 124”). Each image from the input images 104 and/or the output images 124 is an image of one or more utility assets and includes visual features represented in the pixels of the input image, e.g., image features or image data. Examples of utility assets can include transformers, network protectors, utility poles, wires, cables, among other types of electrical equipment used for electric grid generator, transmission, and distribution.

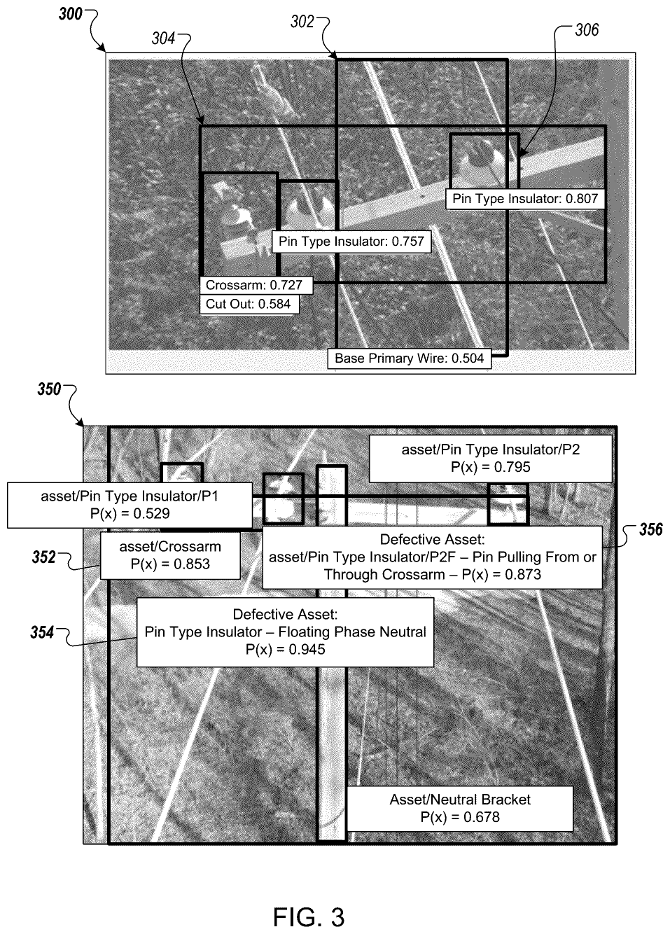

The system 102 is configured to generate, using the input images 104 as an input, output images 124 that include annotations for classifying both asset type and defect class/status for utility assets (including their respective components) identified in an input image from the input images 104. The output images 124 can also include annotations with corresponding probabilities that indicate a likelihood of the annotation indicating both asset type and defect class/status of accurately classifying the utility asset. In some cases, a utility asset includes components that can be individually classified and annotated with a corresponding defect class/status and asset component type, including a respective probability indicating the likelihood of the annotation correctly classifying both asset and defect class/status. For example, an underground network-type transformer includes components such as bushings (e.g., high-voltage bushings, low-voltage bushings), flanges, headers, terminal connections, carriages, gaskets, radiators, among others. The system 102 can be configured to generate output images 124 with annotations that classify types of components for a utility asset (including the asset type itself) and types of defects associated with the utility asset component. In some implementations, the system 102 can generate object annotation data 126, which can include object annotations of joint asset-defect classifications and associated probability data for utility assets from the input images 104. Further examples and description of an example output image 124 is described in reference to FIG. 3 below.

The system 102 includes a two-stage detection framework for jointly modeling asset type and defect status (including defect class). For example, FIG. 1A depicts system 102 having a first detection stage 112 that further includes a deep neural network 114, and a second detection stage 120 that further includes a number of defect classifiers 122-1 through 122-N (collectively “defect classifiers 122”). The deep neural network(s) 114 and the defect classifiers 122 can collectively be referred to as the joint model for the system 102. The first detection stage 112 is trained using training examples that mix different defect statuses for an asset type, e.g., to allow for asset classification inclusive of the defect class for a utility asset. This allows for the first detection stage 112 to classify the asset type for assets that are defective and non-defective, as “defective” and “non-defective” are two statuses for the same object type. In this way, the first detection stage 112 is configured to leverage similar visual signals from the image data, e.g., represented by pixel values and/or feature vectors, because non-defective and defective assets can share an overlapping amount of feature information. The second detection stage 120 is configured to fine-tune asset detection to differentiate, e.g., classify, non-defective assets and defective assets, by the second detection stage 120 being trained to classify assets across different defect statuses of an asset type. Both the first detection stage 112 and the second detection stage 120 are configured to leverage the long-tail nature of utility asset data. For example, categories for asset types can be dependent on the defect status for the asset types, e.g., different classes or statuses of defects, or defective vs. non-defective. Further description of training the first detection stage 112 and the second detection stage 120 is described in reference to FIGS. 1B and 1C below.

The first detection stage 112 is configured to generate asset label data 116 and asset feature embeddings 118 using image data from the input images 104. The asset label data 116 can asset feature embeddings 118 can collectively be referred to as “an asset embedding 117” that maps labels representing asset types (e.g., “pole-type transformer,” “cross arm”) to feature vectors (e.g., normalized pixel values) from the input images 104. In some implementations, the deep neural network 114 is configured to generate an asset embedding is a lower dimensional representation (e.g., compared to a representation and/or dimension of the input images) of the asset in the input image 104, to represent the asset label, e.g., a classification label indicating the type of asset, and related asset feature data, e.g., pixels, data indicating likelihoods of different features. Examples of features can include characteristics of utility assets based on the pixels, e.g., edges, corners, textures, regions, colors, symmetry, blur, gradients, or any combination thereof, that can indicate physical aspects of the detected utility asset, e.g., to classify the asset type.

Although the first detection stage 112 is depicted with a single deep neural network 114, the first detection stage 112 can include a number of deep neural networks 114, e.g., for an ensemble approach to jointly modeling the asset-defect class of a utility asset in an input image. One or more deep neural networks 114 can be configured to generate feature vectors representing feature data of objects, e.g., utility assets, in the input images 104. The feature vectors can be associated with classification labels, depicted as asset label data 116 in FIG. 1A. Examples of data stored in feature vectors can include color, edge detection, gradients, filter response, keypoints, shapes, textures, among others. The deep neural networks 114 can be configured to generate bounding boxes for objects in the input images 104 to indicate a detected object corresponding to one or more of the bounding boxes. The deep neural networks 114 can also be configured to asset label data 116 that includes one or more classification labels corresponding to one or more objects detected in the input image. Examples of classification labels can include labels indicating a type of utility asset, a type of component of the utility asset, a descriptor indicating the position of one component in relation to another, different components of the utility asset, etc. The first detection stage 112 of the system 102 provides the asset embedding 117, e.g., including the asset label data 116 and the asset feature embeddings 118, to the second detection stage 120. The second detection stage 120 includes the defect classifiers 122 that are each trained to determine a type of defect based on the asset embedding 117. The second detection stage 120 is configured to apply a number of techniques such as grouping, applying activation functions, class generation, sampling, and prediction generation prior to providing Further description of training the defect classifiers 122 is described in reference to FIGS. 1B and 1C below.

The second detection stage 120 is configured to generate predictions of annotations that indicate a type of defect for the asset types in an input image. The second detection stage 120 generates output images 124, each output image including annotations of defects for assets in the image. Each annotation in an output image 124 can indicate a label identifying the asset type and a defect status (e.g., defective, non-defective, a class of defect). Examples of defects in the annotations of an output image 124 can include corrosion, cracks, missing insulation or material, or any type of physical (e.g., mechanical, chemical, electrical) defect for the asset. For example, the defect classifiers 122 of the second detection stage 120 can be configured to classify different types of defects based on the asset classification, as some types of defects are more likely to occur with a particular asset type than other types of assets.

Referring to the environment 100, the system 102 is communicatively coupled to a computing device 106 by communication network 110 configured to provide input images 104 to the system 102. In some implementations, the system 102 can obtain input images 104 from a number of image databases depicted as image databases 108-1 through 108-N (collectively “image databases 108”), e.g., directly through the communication network 110. In some implementations, the computing device 106 can be configured to obtain the input images 104 from the image databases 108 and provide the input images 104 to the system 102.

In some implementations, the system 102 is configured to generate an electric grid model output (e.g., a digital map) that includes multiple types of asset data. The electric grid model output 128 in FIG. 1A is an example of a digital model that can further include different types of asset data, e.g., including pixel features from images, image metadata, feeder maps, feeder information, geographical information, among other types of features for utility assets. The system 102 can be configured to perform a reconstruction of the electrical grid using the output images 124 and/or object annotations 126 to improve accuracy and coverage of utility assets in an electric grid. For example, the system 102 can generate electric grid model output 128 based on location information found in the metadata of the input images 104 to generate a geographic utility map. In some implementations, the system 102 can generate electric grid model output 128 based on feeder map information, using information about the connectivity of feeders that are connected to the utility assets and generating an output map, e.g., a graph-based network, a digital map, representing the electric grid. The electric grid model output 128 can connections between different utility assets and connected feeders.

In some implementations, the system 102 can be configured to process training data by up-sampling training examples of defects in utility assets. For example, the models and/or networks of the system 102 can be trained with training examples that include up-sampling the defect classes in the training data. In some implementations, weights in the classifiers can be normalized to favor defect classes, e.g., reweight predictions so that large classes are suppressed (or weighted less than long-tail classes) and long-tail classes are boosted (weighted more than the large classes). In some implementations, a two-stage model, e.g., the first detection stage 112 and the second detection stage 120, respectively of asset detection and defect classification can include training an asset detection model by mixing non-defect assets and defects, and then building defect classifiers 122 on the asset embeddings, e.g., an embedding of asset feature data from the input images 104.

The system 102 can perform a variety of training techniques to annotate input images 104 from the image databases, including supervised and unsupervised learning techniques. In some implementations, the system 102 performs hybrid-learning techniques to improve accuracy of defect classification and asset type detection for utility assets with few examples. The system 102 can adjust one or more weights or parameters for models, substages, neural networks (e.g., deep neural network 114), and asset or defect classifiers, (e.g., defect classifiers 122), such as the first detection stage 112 and the second detection stage 120. By doing so, the asset defect detection system 102 can improve its accuracy generating annotations for output images 124. In some implementations, the models, substages, neural networks, asset and/or defect classifiers, or some combination thereof, include one or more fully or partially connected layers. Each of the layers can include one or more parameter values indicating an output of the layers.

In some implementations, images, e.g., an image from the input images 104, an image from the output images 124, for the asset-defect detection system 102 can be associated with a geographical location of an electric grid. The geographical location can be found in a first type of data from the image metadata, e.g., Exchangeable Image File (EXIF) format. As another example, geographical information can be determined from another type of data from the pixel information of the image. The asset-defect detection system can utilize both types of data (e.g., metadata and pixel data) to determine locations of utility assets. Image metadata can provide an initial estimate of utility asset locations. Multiple instances of the same asset type can be located at a same metadata geographical location. For example, multiple poles captured in the same image can be associated with the same latitude and longitudinal information. By leveraging feature data from image pixels, the asset-defect detection system 102 can provide a visual representation of a particular asset to distinguish the asset from other assets with the same asset type.

FIG. 1B is a diagram of example stages and substages for the asset-defect detection system of FIG. 1A. The environment 140 depicted in FIG. 1B shows the system 102 receiving labeled data 148-1 through 148-N (collectively “labeled data 148”) and input images 104, e.g., referred to FIG. 1A above. The environment 140 depicted in FIG. 1B shows the labeled data 148 being provided to the system 102 as a training example, although the input images 104 can be provided to the system 102 for training using unsupervised learning. For example, the system 102 can perform a number of training iterations to train the deep neural networks 114 of the first detection stage 112 to generate asset embeddings 117. As another example, the system 102 can perform a number of training iterations to train the defect classifiers 122 of the second detection stage 120 to generate a model output such as output images 124, object annotations 126, and/or electric grid model output 128.

An example of labeled data 148 can include an image with annotations indicating both a classification of the utility asset (e.g., an asset type or class) and a classification of the defect status for the utility asset (e.g., a defect status or class). The labeled data 148 can be images that include human-generated annotations, e.g., annotations that are identified and annotated by a human. In some implementations, the labeled data 148 can be a training example that can be an image that includes a classification label to identify a type of utility asset in the input image. The training examples from the labeled data 148 can further include corresponding annotations for the classification label that indicate a defect status of the utility asset. In some implementations, the labeled data 148 can include multiple training examples. Each training example can include feature data from an image of a utility asset, which can be based on image data from the image, e.g., pixel values. The training example can further include an annotation to indicate defect status, e.g., defective or non-defective for the utility asset, but also indicate a defect status and/or classification. The training example can further include classifier weightings corresponding to the annotation generated for the utility asset (e.g., detected object with corresponding defect status from the annotation) in the image.

The environment 140 also shows training feedback loops 113 and 115 to demonstrate a feedback mechanism for training the deep neural networks 114 and the defect classifiers 122, respectively. For example, the system 102 can use the training feedback loop 113 to provide the asset embedding 117 generated by the deep neural network 114 for feedback into the system 102 to train the deep neural networks 114 to generate asset embeddings with improved accuracy, e.g., asset labels that correctly identify utility assets in the input images. As another the example, the system 102 can use the training feedback loop 115 to provide any of the outputs generated by the defect classifiers 122 for feedback into the system 102 to train the defect classifiers 122 to generate model outputs with improved accuracy, e.g., output images with object annotations that correctly identify asset type and defect class/status of utility assets in the output images.

FIG. 1B also shows the second detection stage 120 having multiple substages for processing and analyzing asset embeddings 117, including asset label data 116 and asset feature embeddings 118 generated by the deep neural networks 114. The second detection stage 120 includes a grouping substage 150, an activation function substage 152, a class generation substage 154, a sampling substage 162, and a prediction generation substage 164. The second detection stage 120 includes each of these substages to train the defect classifiers 122, by first providing asset embeddings 117 generated from the labeled data 148 by the deep neural networks 114 in the first detection stage 112.

The system 102 provides the asset feature data to the grouping substage 150. The grouping substage 150 is configured to generate groupings of asset embeddings (hereinafter referred to as “training examples” for the second detection stage 120). The grouping substage 150 can generate groupings based on a count of unique training examples from the received training examples. For example, each asset type of the training examples can be bucketed into a grouping based on a count. Training examples in a grouping can share a count within a threshold value. FIGS. 2A and 2B below show examples of counts for training examples and demonstrate a long-tail distribution of assets and defects for utility assets. The training examples in each grouping also include the corresponding annotations and classifier weightings. Furthermore, the training examples can have a long-tail distribution of the asset-defect classes having a number of head classes, e.g., a class with many training examples (or a high frequency of) relative to the total number of training examples. The long-tail distribution of the asset-defect classes can also have a number of tail classes, e.g., a class with few training examples (or a low frequency of) relative to the total number of training examples.

The system 102 provides the groupings generated by the grouping substage 150 to the activation function substage 152. The activation function substage 152 is configured to apply an activation function to classifier weightings and output transformed weightings for the training examples in the groupings. For example, the activation function substage 152 can apply a non-linear activation function e.g., ReLU, logistic, hyperbolic tangent, to the output of the classifier weightings. In some implementations, the activation function substage 152 applies a softmax activation function to each grouping such that the classifier weightings for asset types with more training data, e.g., higher counts, are not over-represented for predictions by the defect classifiers 122, e.g., compared to asset types with lower counts. In some cases, the activation function substage 152 can apply a group softmax to the groupings, e.g., a softmax for each asset type.

The system 102 provides the transformed weightings of the training examples and the related training data (e.g., including the annotation and the feature data for the training example) from the activation function substage 152 to the class generation substage 154. The class generation substage 154 is configured to generate, for each grouping, an others class 156 and a background class 158 using the transformed weightings of the training examples. The others class 156 for a grouping of training examples includes a counter-training example that is an “opposite” class of the class for a training example in the grouping. For example, the others class 156 for a grouping with a training example that has an asset type with a defect status of “non-defective” would be a counter-training example that has with the same asset type but a different defect status of “defective.” The others class 156 for a grouping can be a subset of training examples that are not included in the grouping. The background class 158 for a grouping of training examples is an empty grouping that can be populated with sampled feature data by the sampling substage 162, as described below.

In some implementations, the class generation substage 154 can determine that a grouping does not include a defective training example, e.g., an asset embedding for a utility asset that is not defective. For groupings without defective training examples, the class generation substage 154 generates an “others class 156” that is sampled from the others classes 156 for the other groupings. For example, if a first grouping does not include a defective training example, the class generation substage 154 generates an “others class 156” from asset embeddings of the others class 156 of groupings that are different from the first grouping. The “others class 156” for each grouping provides improved accuracy to calibrate predictions and suppress false positives, e.g., reducing the likelihood of classifying an asset as defective when the asset is non-defective.

The system 102 provides the groupings of the training examples, including the other classes 156 and the empty background classes 158 for each of the groupings, to the sampling substage 162. The sampling substage 162 samples the feature data for training examples in each grouping and stores the sampled feature data in the “backgrounds class 158” of the respective grouping being sampled. In this way, the sampling substage 162 embeds the feature space spanned by background and other classes, i.e. non-defective classes. They serve as “negative examples” for the defect classifiers 122 to differentiate defects (e.g., “positive examples”) from non-defects. The sampling substage 162 samples data because the backgrounds class for utility assets can be significantly larger than the defect classes, and thus the data sampling helps to balance different classes for generating predictions, e.g., at a prediction substage 164. The output of the sampling substage 162 is a backgrounds class 158 for each grouping from the groupings of training examples.

The system 102 provides the groupings of the training examples, the others classes 156 for the groupings, and the background classes 158, e.g., populated with the sampled feature data from the sampling substage 162, to the prediction generation substage 164. The prediction generation substage 164 includes the defect classifiers 122 and generates a predicted annotation for each training example in each grouping. The prediction generation substage 164 generates a predicted annotation for each training example based on the classifiers trained to differentiate the defective classes 122 from the other classes 156 and the background class 158. The prediction generation substage 164 can be trained to identify a particular classifier or a subset of classifiers from the defect classifiers 122 that have a higher classification accuracy, e.g., than other classifiers in the defect classifiers 122. A defect classifier with higher classification accuracy is trained by learning patterns of defect features from the others classes 156 and the backgrounds class 158, thereby improving overall prediction accuracy for model outputs, e.g., output images 124. The prediction generation substage 164 can be configured to compare the predicted annotation to a ground truth annotation for the training example, e.g., from the annotation for the training example in the labeled data 148.

The prediction generation substage 164 can be configured to update weights of one or more defect classifiers based on the comparison, e.g., the asset type from the predicted annotation does not match the asset type of the ground truth asset type, the defect status or type from the predicted annotation does not match the defect status or type of the ground truth asset type, or some combination thereof. The predicted annotation can indicate a predicted type and a predicted defect status of the utility asset in the image for the training example. The annotation can indicate a ground truth label indicating the type and a ground truth label indicating the defect status of the utility asset in the image for the training example.

FIG. 1C is a diagram of another example for training the joint asset-defect detection system of FIG. 1A. The environment 170 depicted in FIG. 1C shows the deep neural network 114 receiving labeled data 148 and generating an asset embedding 117, which is then provided to the second stage 120. The deep neural network 114 can be trained using training examples that mix asset types and defect status. The environment 170 shows an implementation of the second stage 120 having a number of groupings 172-1 through 172-N (collectively referred to as “groupings 172”) and a shared head feature 174. As described in reference to FIG. 1B above, each grouping from the groupings 172 includes an others class, but can also include a number of head classes and/or tail classes. The first grouping 172-1 includes training examples from an others class and a background class but does not include training examples from a head or tail class. The second grouping 172-2 includes training examples from an others class and training examples from multiple head classes. The last grouping 172-N includes training examples from an others classes and training examples from multiple tail classes. The shared head feature 174 can be a part of the defect classifiers 122 to generate predicted annotations from feature data of the training examples in each grouping.

The predicted annotations include an annotation, but also include a value representing a likelihood of the annotation indicating the correct asset type and defect class/status for the training example. The system 102 can apply a fine tuning layer 176 to the predicted annotations from the second stage 120 to differentiate non-defect assets and defect assets, e.g., for groupings without defective training examples to generate the others class. In cases where the output probability from the defect classifiers 122 has not been normalized, the system 102 can apply a normalization layer 178 to the outputs of the second stage from the predicted annotations to generate a probability value for the predicted annotation from raw output values of neural network layers from the defect classifiers 122. The second stage 120 can determine a cross-entropy loss between a distribution of the probabilities from the predicted annotations and the ground truth annotations. A model output 180 can be generated from the normalization layer 178 for output by the system 102.

In some implementations, the system 102 may adjust a penalty parameter to train the deep neural networks 114 and/or the defect classifiers 122, also referred to as “the joint asset-defect detection model” of the system 102. In some implementations, parameters adjusted in models (e.g., networks, classifiers) of the system 102 can be learned e.g., by a neural network. In some implementations, adjusted model parameters can include coefficients or weights of a neural network, biases of a neural network, and cluster centroids in clustering networks. In some implementations, hyperparameters e.g., parameters to adjust learning of the system 102, can be adjusted for training the models. Hyperparameters may include a test-train split ratio, learning rates, selection of optimization algorithms, selection of functions e.g., activation, cost, or loss functions, a number of hidden layers, a dropout rate, a number of iterations, a number of clusters, a pooling size, a batch size, and a kernel or filter size in convolutional layers.

The system 102 can use any appropriate algorithm such as backpropagation of error or stochastic gradient descent for training the models. The models of the system 102 can be evaluated for error and accuracy over a validation set of labeled images. The model training continues until either a timeout occurs, e.g., typically several hours, or a predetermined error or accuracy threshold is reached. In some implementations, an ensemble approach of models, such as different deep neural networks for different asset types and/or different defect classifiers for different defect classes/statuses, can be implemented by the system to improve overall accuracy of joint asset and defect detection. Model training and re-training of the models can be performed repeatedly at a pre-configured cadence e.g., once a week, once a month, and if new data is available, then it automatically gets used as part of the training.

In some implementations, one or both of the deep neural networks 114 and the defect classifiers 122 can include feed-forward neural networks with multiple feed-forward layers. Each feed-forward neural network can include multiple fully-connected layers, in which each fully-connected layer applies an affine transformation to the input to the layer, i.e., multiplies an input vector to the layer by a weight matrix of the layer. In some implementations, the system 102 can include be configured to perform regression to train the model, e.g., linear, logistic, polynomial, RIDGE, LASSO techniques.

FIG. 2A is an example table 200 depicting counts of utility asset and defect labels. The table 200 shown in FIG. 2A shows a first column of labels associated with detected objects and their defect status, while a second column shows a count of training examples that include an annotation with the label indicated in the first column. The rows of table 200 are sorted by highest count to lowest count for the labels, e.g., from top to bottom of table 200. For example, an asset of a bare primary wire is depicted in the first row of table 200 as “asset/Bare Primary Wire” with a count of “3611” instances in the training examples. Similarly, the table 200 shows labels for assets in dark gray shading such as “asset/Pin Type Insulator,” “asset/Crossarm,” and “asset/Dead End Type Insulator” with counts “2202,” “1379,” and “1133,” respectively. Table 200 also shows labels with grey shading, indicating training examples of assets with a type of defect indicated in the label. For example, the last row of table 200 shows a label for a training example (e.g., an image of a utility asset) of a crossarm (e.g., for a pole-type transformer or pole structure) having lightning flashover burn marks, indicated by “asset/Crossarm/P4D-Lightning Flashover Burn Marks,” with a count of “1.” This indicates a single example of a training example of this particular type of defect (e.g., lightning burn marks) for this asset type (e.g., crossarm).

As another example, the assets highlighted in dark gray in table 200 demonstrate training examples that include a sufficient number of examples to train an asset detection model, e.g., above a threshold value, a threshold order of magnitude larger than counts for defective assets. Although the counts depicted in FIG. 2A results from an unbalanced image dataset, the largest category (“Bare Primary Wire” with count “3611”) among the highlighted training examples is over ten times larger in counts than the smallest category (“Transformer” with count “273”) among the highlighted training examples. However, the largest defect category (“Crossarm/P2B—Broken Cracked Crossarm”) has 23 examples among the total image dataset, e.g., nearly 11,000 images. In some cases, it may not be feasible to collect enough training examples to train a defect detection model, given the few numbers of training examples available, e.g., compared to assets without defects. The joint model is configured to be jointly trained as both an asset and defect detection model, as non-defect assets and defective assets are two statuses of the same object, e.g., defects indicate assets that are defective. For example, “Crossarm/P2B—Broken Cracked Crossarm” indicates a crossarm for a pole-type transformer is broken, e.g., one or more cracks appear in the crossarm based on visual inspection of the image of the cross-arm.

FIG. 2B is an example histogram 250 depicting a long-tail distribution of the counts in FIG. 2A. The histogram 250 shows the counts of different labels indicated in table 200 depicted in FIG. 2A. The histogram 250 shows that labels for asset types with non-defective status have higher counts (e.g., in the hundreds or thousands) than asset types with defective status (e.g., fewer than 25 training examples). The histogram 250 shows statistics for utility assets and defects from labeled image data, e.g., labeled data 148 described in reference to FIG. 1B above.

FIG. 3 is an example of annotated output images generated by an asset-defect detection system. FIG. 3 depicts annotated output images 300 and 350 (also referred to as output images 300 and 350), each including a number of annotations indicating an asset type and defect class/status with a corresponding probability of accurate classification. The output image 300 and 350 can be examples of a model output 180 (referring to FIG. 1C above), as well as examples of an output image 124 and/or object annotations 126, described in reference to FIGS. 1A and 1C above. The output images 300 and 350 also show bounding boxes indicating detect objects in the image, e.g., different types of assets and/or asset components.

The output image 300 depicted in FIG. 3 is an example of an output image with asset detection. For example, the output image 300 shows bounding boxes 302, 304, and 306 (among others depicted in FIG. 3) depicted as rectangular black rectangles enclosing regions of pixels in the output image 300. The bounding box 302 encloses a region of pixels in the output image 300 classified as “Base Primary Wire” with corresponding likelihood P(x)=0.504, while the bounding box 304 encloses a second region of pixels that is partially overlapping with the region of pixels enclosed by bounding box 302. The detected object indicated by bounding box 304 is annotated as a cross-arm in output image 300 with corresponding likelihood P(x)=0.727, whereas the detected object indicated by bounding box 306 is annotated as a pin type insulator with corresponding likelihood P(x)=0.807.

In contrast to output image 300, the output image 350 is an output generated by the joint model leveraging long-tail distributions of asset type and defect status to predict both asset type and defect class. Annotations in the output image 350 without an indication of “Detective Asset” can indicate non-defective assets, whereas annotations indicating “Defective Asset” also include a defect status/class in addition to the asset classification. The output image 350 includes an annotation 352 indicating the detection of a Crossarm with non-defective status and a corresponding probability P(x)=0.853. The annotation 354 shows a detection for a defective Pin Type Insulator, e.g., a utility asset with asset type of “Pin Type Insulator,” a defect class/status of “floating phase neutral,” and a corresponding likelihood P(x)=0.945. A floating phase neutral defect in an electric utility asset can indicate a disconnected or improperly connected neutral conductor (e.g., a neutral wire) in the utility asset, which can result in voltage imbalance, damage to the utility asset, inoperability or reduce operability of the utility asset, and a potential safety hazard from electrical shock. In some implementations, the annotation also includes a type of defect. For example, annotation 356 indicates a Pin Type insulator with a defect of “pin pulling from or through crossarm” and having a corresponding likelihood P(x)=0.873. A pin pulling from or through cross arm defect for a pin type insulator can indicate that a pin that couples the pin-type insulator to the cross-arm is displaced, resulting in improper support for the insulator that can further result in insulation failure, e.g., electrical faults or short circuits.

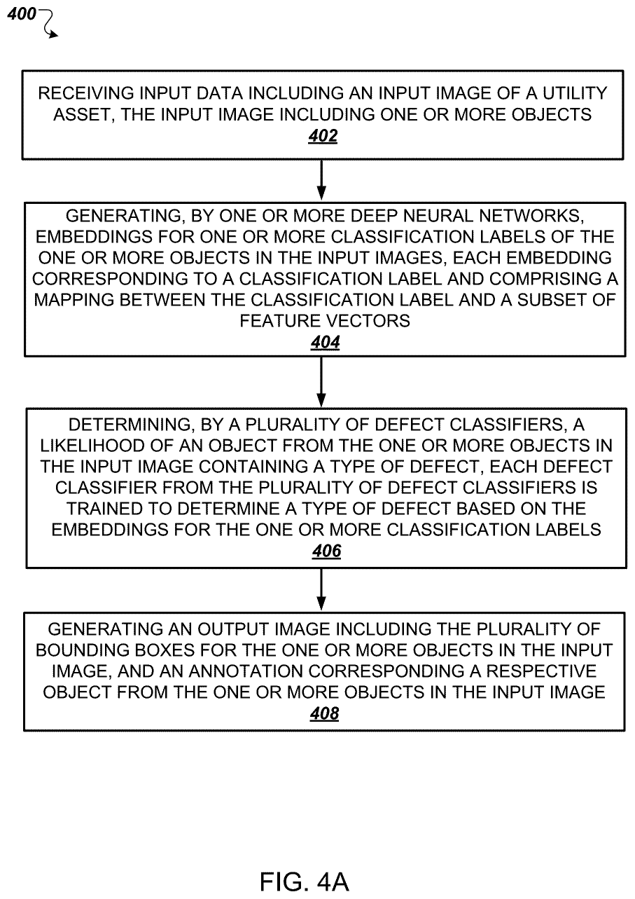

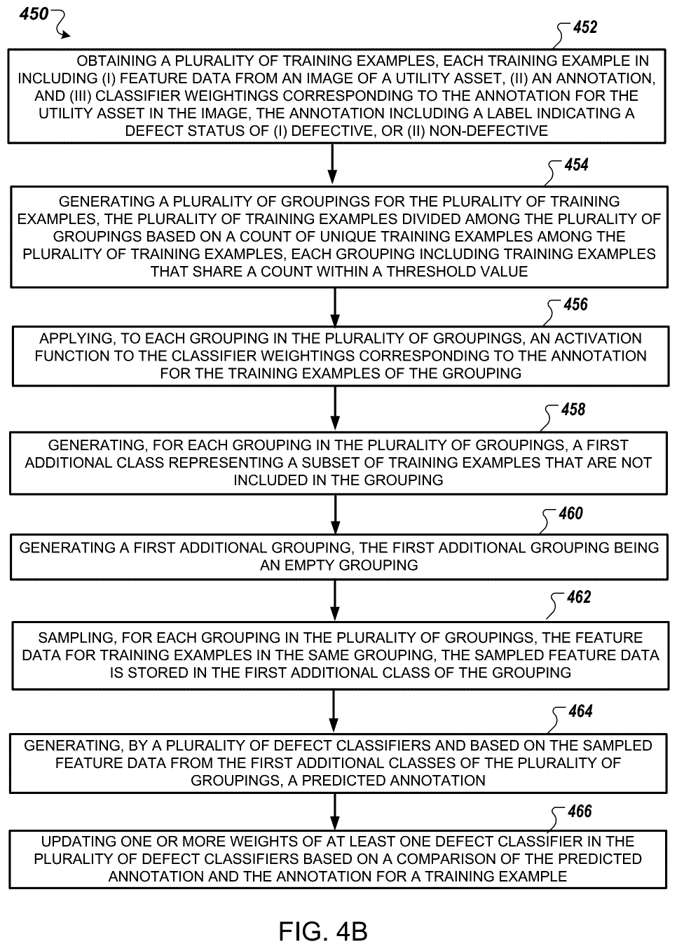

FIG. 4A is a flowchart illustrating an example process 400 performed by a joint asset-defect detection system. The process 400 can be performed by the joint asset-defect detection system, e.g., system 102 configured to obtain input images of utility assets, e.g., input images 104, and generate output images with annotations indicating asset type and defect status/class, e.g., output images 124, as described in reference to FIGS. 1A, 1B, and 1C.

The joint asset-defect detection system receives input data that includes an input image of a utility asset, the input image including one or more objects (402). The input images can be, for example, input images 104 that include utility assets and can be provided to the system 102 by a communication network, e.g., communication network 110. In some implementations, the input images are provided to the system from a computing device, e.g., a computing device 106. In some implementations, the input images are received from image databases, e.g., image databases 108.

The joint asset-defect detection system generates, by one or more deep neural networks, embeddings for one or more classification labels of the one or more objects in the input images (404). Each embedding corresponds to a classification label and each embedding includes a mapping between the classification label and a subset of feature vectors. The one or more deep neural networks, e.g., deep neural networks 114, can be part of a first stage of the joint asset-defect detection system 102, e.g., first detection stage 112. The deep neural networks can generate embeddings, e.g., asset embeddings 117, that include data related to the asset label, e.g., asset label data 116, and embeddings of asset feature data, e.g., asset feature embeddings 118. The asset label can include a classification of asset type and the deep neural network 114 can be configured to perform the classification on input images 104 that include asset types with both classes of defect statuses, e.g., defective and non-defective.

The joint asset-defect detection system determines, by a plurality of defect classifiers, a likelihood of an object from the one or more objects in the input image containing a type of defect (406). Each defect classifier from the plurality of defect classifiers is trained to determine a type of defect based on the embeddings for the one or more classification labels. The embeddings can be provided to a second detection stage, e.g., a second detection stage 120, that includes defect classifiers, e.g., defect classifiers 122. The defect classifiers can be trained to classify based on the asset label data and the asset feature embeddings to generate predictions indicating both asset type and defect status/class. By mixing asset types and defect classes in the input images and leveraging the long-tail distribution of defect classes (including defect status) across asset types, the defect classifiers can generate predicted annotations in output images that indicate the asset type and defect class/status for a detected object from the input image.

The joint asset-defect detection system generates an output image including the plurality of bounding boxes for the one or more objects in the input image and an annotation corresponding a respective object from the one or more objects in the input image (408). In some implementations, the annotation includes a classification label and a likelihood associated with the classification label. The classification label indicates an asset type and defect status for the respective object, and the likelihood associated with the classification label represents a probability of the respective object in the input image matching the asset type and the defect status. Examples of output images with annotations indicating one or both of asset type and defect status/class.

In some implementations, the process 400 includes generating, by one or more deep neural networks, the plurality of bounding boxes for the one or more objects in the input image. Each bounding box in the plurality of bounding boxes corresponds to an object from the one or more objects in the input image for the utility asset. In some implementations, the corresponding bounding box for an object indicates a position of the respective object in the output image.

In some implementations, the process 400 includes generating, by one or more deep neural networks, asset label data for the one or more objects in the input image. The asset label data can include the one or more classification labels corresponding to the one or more objects in the input image. Each classification label represents a type of utility asset.

In some implementations, the process 400 includes generating, by one or more deep neural networks, asset feature data for one or more objects in the input image. The asset feature data includes a plurality of feature vectors, the feature vectors representing features of the one or more objects in the input image. The subset of feature vectors includes at least one of the plurality of feature vectors.

In some implementations, the process 400 includes generating, for input images of one or more utility assets, output images corresponding to the input images. Each output image from the output images includes (i) bounding boxes, and (ii) annotations, for objects in the respective input image. The process 400 can include generating, using the output images, a model representation of an electric grid including the one or more utility assets from the input images. For example, the system 102 can receive multiple input images of utility assets for at least a portion of an electric grid, e.g., a subset of utility assets belonging to a particular feeder of the electric grid, to generate a model representation, e.g., an interactive image map of an electric grid based on the output images 124. The model representation can include bounding boxes and annotations for the utility assets classified and detected by the system 102 and can be provided for display on a computing device, e.g., computing device 106.

FIG. 4B is a flowchart illustrating an example training process 450 performed by a joint asset-defect detection system. The process 450 can be performed by the joint asset-defect detection system 102 configured to train models for joint asset-defect detection, e.g., detecting utility asset types and defect classes from input images, as described in reference to FIGS. 1B and 1C.

The joint asset-defect detection system obtains a plurality of training examples, each training example in the plurality of training examples including (i) feature data from an image of a utility asset, (ii) an annotation, and (iii) classifier weightings corresponding to the annotation for the utility asset in the image (452). The annotation includes a label indicating a defect status of (i) defective, or (ii) non-defective. The training examples can be an example of labeled data, e.g., labeled data 148.

The joint asset-defect detection system generates a plurality of groupings for the plurality of training examples, the plurality of training examples divided among the plurality of groupings based on a count of unique training examples among the plurality of training examples (454). Each grouping includes training examples that share a count within a threshold value. The groupings can be generated by a grouping substage, e.g., grouping substage 150 of the second detection stage, e.g., second detection stage 120, of the joint asset-defect detection system, described in reference to FIG. 1B above.

The joint asset-defect detection system applies, to each grouping in the plurality of groupings, an activation function to the classifier weightings corresponding to the annotation for the training examples of the grouping (456). The activation function can be applied by an activation function substage, e.g., activation function substage 152 of the second detection stage, e.g., second detection stage 120, of the joint asset-defect detection system, described in reference to FIG. 1B above.

The joint asset-defect detection system generates, for each grouping in the plurality of groupings, a first additional class representing a subset of training examples that are not included in the grouping (458). The first additional class can be generated by a class generation substage, e.g., class generation substage 154, of the second detection stage, e.g., second detection stage 120, of the joint asset-defect detection system, described in reference to FIG. 1B above. Examples of the first additional class can include the others classes, e.g., “others classes 156,” described in reference to FIGS. 1B and 1C above.

The joint asset-defect detection system generates a first additional grouping that is an empty grouping (460). The first additional grouping can be generated by a class generation substage, e.g., class generation substage 154, of the second detection stage, e.g., second detection stage 120, of the joint asset-defect detection system, described in reference to FIG. 1B above. Examples of the first additional grouping can include the background classes, e.g., “background classes 158,” described in reference to FIG. 1B and 1C above.

The joint asset-defect detection system samples, for each grouping in the plurality of groupings, the feature data for training examples in the same grouping (462). The sampled feature data is configured to be stored in the first additional class of the grouping. The sampling of feature data can be performed by a sampling substage, e.g., sampling 162, of the second detection stage, e.g., second detection stage 120, of the joint asset-defect detection system, described in reference to FIG. 1B above.

The joint asset-defect detection system generates, by a plurality of defect classifiers and based on the sampled feature data from the first additional classes of the plurality of groupings, a predicted annotation (464). Defect classifiers, such as defect classifiers 122 of a prediction generation substage, e.g., prediction generation substage 164 of the second detection stage, e.g., second detection stage 120, of the joint asset-defect detection system can generate model outputs such as the predicted annotations.

In some implementations, generating the predicted annotation for one or more objects in an input image includes providing a training example to a model configured to perform asset-defect detection. The training example includes (i) a classification label for a respective object of the one or more objects indicating a type of utility asset and (ii) an annotation for the respective object of the one or more objects indicating a defect status of the utility asset.

In some implementations, the plurality of defect classifiers are configured to determine, based on embeddings generated for one or more classification labels of one or more objects, an updated bounding box for an output image. The updated bounding box can have a higher likelihood of identifying an object in an input image than the respective bounding box for the object from the plurality of bounding boxes.

The joint asset-defect detection system updates one or more weights of at least one defect classifier in the plurality of defect classifiers based on a comparison of the predicted annotation and the annotation for a training example (466). The annotation indicates a type and defect status of the utility asset in the image and the predicted annotation indicates a predicted type and a predicted defect status of the utility asset in the image.

In some implementations, the process 450 includes up-sampling, for each grouping in the plurality of groupings, a subset of training examples, each training example in the subset including a defect status with a label of defective. Up-sampling the grouping can include sampling corresponding feature data of the subset of training examples at least one additional time when training the plurality of defect classifiers.

In some implementations, the process 400 includes normalizing, for each grouping in the plurality of groupings, the classifier weightings for training examples with a number of counts exceeding a threshold value in the grouping.

In some implementations, the utility asset can include one or more of (i) a utility pole, (ii) a transformer, (iii) one or more wires, or (iv) other types of electrical grid distribution equipment.

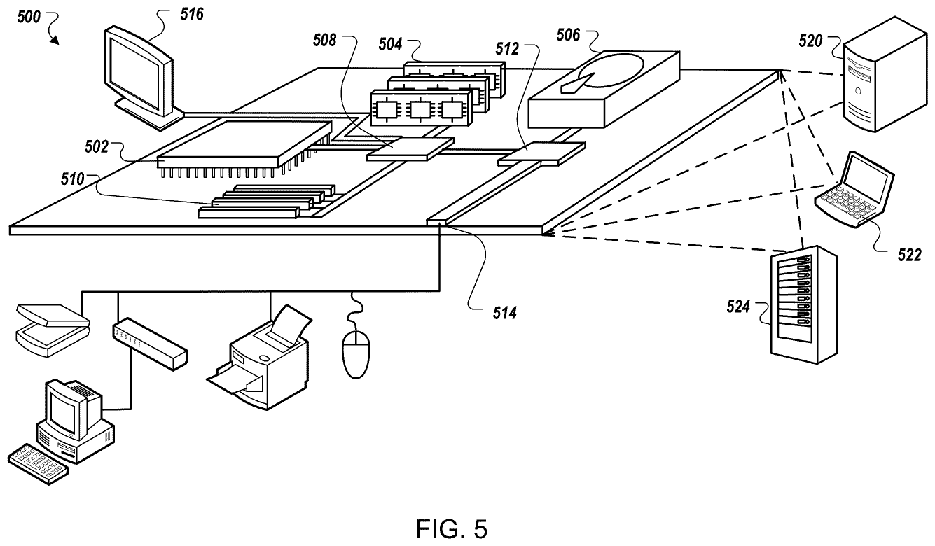

FIG. 5 is a diagram illustrating an example of a computing system used in an image search-based object detection system. The computing system includes computing device 500 that can be used to implement the techniques described herein. For example, one or more components of the asset-defect detection system 102 could be an example of the computing device 500.

The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be examples only and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various buses, and may be mounted on a common motherboard or in other manners as appropriate. The processor 502 can process instructions for execution within the computing device 500, including instructions stored in the memory 504 or on the storage device 506 to display graphical information for a Graphical User Interface (GUI) on an external input/output device, such as a display 516 coupled to the high-speed interface 508. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 502 is a single threaded processor. In some implementations, the processor 502 is a multi-threaded processor. In some implementations, the processor 502 is a quantum computer.

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer-or machine-readable mediums (for example, the memory 504, the storage device 506, or memory on the processor 502). The high-speed interface 508 manages bandwidth-intensive operations for the computing device 500, while the low-speed interface 512 manages lower bandwidth-intensive operations. Such allocation of functions is an example only. In some implementations, the high speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device. Each of such devices may include one or more of the computing device 500, and an entire system may be made up of multiple computing devices communicating with each other.

A number of implementations have been described. Nevertheless, it will be understood that various modifications may be made without departing from the spirit and scope of the disclosure. For example, various forms of the flows shown above may be used, with steps re-ordered, added, or removed.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively in communication to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, a Microsoft Cognitive Toolkit framework, an Apache Singa framework, or an Apache MXNet framework.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any subject matter that may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method for joint asset and defect detection, the method comprising:
receiving input data comprising an input image of a utility asset, the input image comprising one or more objects;
generating, by one or more deep neural networks, embeddings for one or more classification labels of the one or more objects in the input images, each embedding corresponding to a classification label and comprising a mapping between the classification label and a subset of feature vectors;
determining, by a plurality of defect classifiers, a likelihood of an object from the one or more objects in the input image containing a type of defect, wherein each defect classifier from the plurality of defect classifiers is trained to determine a type of defect based on the embeddings for the one or more classification labels; and
generating an output image comprising a plurality of bounding boxes for the one or more objects in the input image, and an annotation corresponding a respective object from the one or more objects in the input image.

2. The method of claim 1, further comprising generating, by one or more deep neural networks, the plurality of bounding boxes for the one or more objects in the input image, wherein each bounding box in the plurality of bounding boxes corresponds to an object from the one or more objects in the input image for the utility asset.

3. The method of claim 1, further comprising generating, by one or more deep neural networks, asset label data for the one or more objects in the input image, wherein the asset label data comprises the one or more classification labels corresponding to the one or more objects in the input image, each classification label representing a type of utility asset.

4. The method of claim 1, further comprising generating, by one or more deep neural networks, asset feature data for one or more objects in the input image, wherein the asset feature data comprises a plurality of feature vectors, the feature vectors representing features of the one or more objects in the input image, and wherein the subset of feature vectors comprises at least one of the plurality of feature vectors.

5. The method of claim 1, wherein the corresponding bounding box for an object indicates a position of the respective object in the output image.

6. The method of claim 1, further comprising:
generating, for input images of one or more utility assets, output images corresponding to the input images, wherein each output image from the output images comprises (i) bounding boxes, and (ii) annotations, for objects in the respective input image, and
generating, using the output images, a model representation of an electric grid comprising the one or more utility assets from the input images.

7. The method of claim 1, wherein the annotation comprises a classification label and a likelihood associated with the classification label, the classification label indicating an asset type and defect status for the respective object, and the likelihood associated with the classification label represents a probability of the respective object in the input image matching the asset type and the defect status.

8. A method for training a joint asset and defect detection model, the method comprising:
obtaining a plurality of training examples, wherein each training example in the plurality of training examples comprises (i) feature data from an image of a utility asset, (ii) an annotation, and (iii) classifier weightings corresponding to the annotation for the utility asset in the image, wherein the annotation comprises a label indicating a defect status of (i) defective, or (ii) non-defective;
generating a plurality of groupings for the plurality of training examples, wherein the plurality of training examples are divided among the plurality of groupings based on a count of unique training examples among the plurality of training examples, each grouping including training examples that share a count within a threshold value;
applying, to each grouping in the plurality of groupings, an activation function to the classifier weightings corresponding to the annotation for the training examples of the grouping;
generating, for each grouping in the plurality of groupings, a first additional class representing a subset of training examples that are not included in the grouping;
generating a first additional grouping, wherein the first additional grouping is an empty grouping;
sampling, for each grouping in the plurality of groupings, the feature data for training examples in the same grouping, wherein the sampled feature data is configured to be stored in the first additional class of the grouping;
generating, by a plurality of defect classifiers and based on the sampled feature data from the first additional classes of the plurality of groupings, a predicted annotation; and
updating one or more weights of at least one defect classifier in the plurality of defect classifiers based on a comparison of the predicted annotation and the annotation for a training example.

9. The method of claim 8, wherein the annotation indicates a type and defect status of the utility asset in the image and the predicted annotation indicates a predicted type and a predicted defect status of the utility asset in the image.

10. The method of claim 8, further comprising:
up-sampling, for each grouping in the plurality of groupings, a subset of training examples, each training example in the subset comprising a defect status with a label of defective, wherein up-sampling the grouping comprises sampling corresponding feature data of the subset of training examples at least one additional time when training the plurality of defect classifiers.

11. The method of claim 8, further comprising:
normalizing, for each grouping in the plurality of groupings, the classifier weightings for training examples with a number of counts exceeding a threshold value in the grouping.

12. The method of claim 8, wherein the utility asset is at least one of (i) a utility pole, (ii) a transformer, (iii) one or more wires, or (iv) other types of electrical grid distribution equipment.

13. The method of claim 8, wherein the plurality of defect classifiers are configured to determine, based on embeddings generated for one or more classification labels of one or more objects, an updated bounding box for an output image,
wherein the updated bounding box has a higher likelihood of identifying an object in an input image than the respective bounding box for the object from the plurality of bounding boxes.

14. The method of claim 8, wherein generating the predicted annotation for one or more objects in an input image comprises providing a training example to a model configured to perform asset-defect detection, wherein the training example comprises (i) a classification label for a respective object of the one or more objects indicating a type of utility asset and (ii) an annotation for the respective object of the one or more objects indicating a defect status of the utility asset.

15. A system for joint asset and defect detection, the system comprising:
one or more computers and one or more storage devices storing instructions that are operable, when executed by the one or more computers, to cause the one or more computers to perform operations comprising:
receiving input data comprising an input image of a utility asset, the input image comprising one or more objects;
generating, by one or more deep neural networks, embeddings for one or more classification labels of the one or more objects in the input images, each embedding corresponding to a classification label and comprising a mapping between the classification label and a subset of feature vectors;
determining, by a plurality of defect classifiers, a likelihood of an object from the one or more objects in the input image containing a type of defect, wherein each defect classifier from the plurality of defect classifiers is trained to determine a type of defect based on the embeddings for the one or more classification labels; and
generating an output image comprising the plurality of bounding boxes for the one or more objects in the input image, and an annotation corresponding a respective object from the one or more objects in the input image.

16. The system of claim 15, the operations further comprising:
obtaining a plurality of training examples, wherein each training example in the plurality of training examples comprises (i) feature data from an image of a utility asset, (ii) an annotation, and (iii) classifier weightings corresponding to the annotation for the utility asset in the image, wherein the annotation comprises a label indicating a defect status of (i) defective, or (ii) non-defective;
generating a plurality of groupings for the plurality of training examples, wherein the plurality of training examples are divided among the plurality of groupings based on a count of unique training examples among the plurality of training examples, each grouping including training examples that share a count within a threshold value;
applying, to each grouping in the plurality of groupings, an activation function to the classifier weightings corresponding to the annotation for the training examples of the grouping;
generating, for each grouping in the plurality of groupings, a first additional class representing a subset of training examples that are not included in the grouping;
generating a first additional grouping, wherein the first additional grouping is an empty grouping;
sampling, for each grouping in the plurality of groupings, the feature data for training examples in the same grouping, wherein the sampled feature data is configured to be stored in the first additional class of the grouping;
generating, by a plurality of defect classifiers and based on the sampled feature data from the first additional classes of the plurality of groupings, a predicted annotation; and
updating one or more weights of at least one defect classifier in the plurality of defect classifiers based on a comparison of the predicted annotation and the annotation for a training example.

17. The system of claim 15, wherein the operations further comprise:
generating, by one or more deep neural networks, the plurality of bounding boxes for the one or more objects in the input image, wherein each bounding box in the plurality of bounding boxes corresponds to an object from the one or more objects in the input image for the utility asset.

18. The system of claim 15, wherein the operations further comprise:
generating, by one or more deep neural networks, asset label data for the one or more objects in the input image, wherein the asset label data comprises the one or more classification labels corresponding to the one or more objects in the input image, each classification label representing a type of utility asset.

19. The system of claim 15, wherein the operations further comprise:
generating, by one or more deep neural networks, asset feature data for one or more objects in the input image, wherein the asset feature data comprises a plurality of feature vectors, the feature vectors representing features of the one or more objects in the input image, and wherein the subset of feature vectors comprises at least one of the plurality of feature vectors.

20. The system of claim 15, wherein the annotation comprises a classification label and a likelihood associated with the classification label, the classification label indicating an asset type and defect status for the respective object, and the likelihood associated with the classification label represents a probability of the respective object in the input image matching the asset type and the defect status.
